(19) United States
(12) Patent Application Publication
(10) Pub. No.: US 2020/0270515 A1
(43) Pub. Date: Aug. 27, 2020

(54) ARTICLE WITH A COLOR-TUNING LAYER

(71) Applicant: VIAVI SOLUTIONS INC., San Jose, CA (US)

(72) Inventors: Jaroslaw ZIEBA, Santa Rosa, CA (US); Johannes P. SEYDEL, Petaluma, CA (US); Kangning LIANG, Santa Rosa, CA (US)

(73) Assignee: VIAVI SOLUTIONS INC., San Jose, CA (US)

(21) Appl. No.: 16/796,678

(22) Filed: Feb. 20, 2020

Related U.S. Application Data
(60) Provisional application No. 62/808,672, filed on Feb. 21, 2019.

(51) Int. Cl. C09K 9/02; C09B 9/00; C09B 57/00; G02F 1/01

(52) U.S. Cl. CPC C09K 9/02; C09B 9/00; G02F 1/0126; G02F 1/0147; C09B 57/00

(57) ABSTRACT

A flake including a reflector layer having a first surface, and a second surface opposite the first surface; and a first selective light modulator layer external to the first surface; wherein the first selective light modulator layer includes a colorant having a first color that changes to a second color upon application of energy is disclosed. A method of making a composition is also disclosed.

### RELATED APPLICATION

The present application claims priority to U.S. Provisional Application No. 62/808,672, filed on Feb. 21, 2019, the entire disclosure of which is hereby incorporated by reference.

### FIELD OF THE INVENTION

The present disclosure generally relates to articles, such as optical devices in the form of foil, sheets, and/or flakes. The article can include a reflector layer having a first surface, and a second surface opposite the first surface; and first a selective light modulator layer (“SLML”), external to the first surface; wherein the first selective light modulator layer can include a colorant having a first color that changes to a second color upon application of energy. Methods of making the optical devices are also disclosed.

### BACKGROUND OF THE INVENTION

Metallic effect pigments offer a set value of color parameters that are constant independent of ambient lighting conditions. The metallic effect pigments are limited and are not able to provide the most attractive esthetic viewing experience under given lighting conditions. The esthetic appeal of certain colors may therefore appear dull or “boring” under certain viewing conditions.

### SUMMARY OF THE INVENTION

In an aspect, there is disclosed a reflector layer having a first surface, and a second surface opposite the first surface; and a first selective light modulator layer external to the first surface; wherein the first selective light modulating layer includes a colorant having a first color that changes to a second color upon application of energy.

In another aspect, there is disclosed a method of making a composition, comprising providing a flake including a reflector layer having a first surface, and a second surface opposite the first surface; and a first selective light modulator layer external to the first surface; wherein the first selective light modulator layer includes a colorant having a first color that changes to a second color upon application of energy; blending a liquid medium with the flake; and applying energy to the composition to tune the first selective light modulator layer in each flake from the first color to the second color.

Additional features and advantages of various embodiments will be set forth, in part, in the description that follows, and will, in part, be apparent from the description, or can be learned by the practice of various embodiments. The objectives and other advantages of various embodiments will be realized and attained by means of the elements and combinations particularly pointed out in the description herein.

### DETAILED DESCRIPTION OF THE INVENTION

It is to be understood that both the foregoing general description and the following detailed description are exemplary and explanatory only, and are intended to provide an explanation of various embodiments of the present teachings. In its broad and varied embodiments, disclosed herein are articles, such as optical devices, for example, in the form of foils, sheets, and flakes; and a method of manufacturing the article. In an example, the article can be a flake including a reflector layer and at least one selective light modulator layer (SLML), such as a first SLML and/or a second SLML.

The article can be in the form of a flake comprising a reflector layer; and a first selective light modulator layer in which the SLML includes a colorant having a first color that changes to a second color upon application of energy. For example, as described in further detail below, the appearance of color can be generated by including a selective light modulator system (SLMS), such as an additive, for example a colorant, a selective light modulator particle (SLMP) or a selective light modulator molecule (SLMM) in the SLML. The article can be a metallic flake shaped pigment with color parameters, such as hue, chroma, and lightness, that can undergo a self-tuning process depending on viewing the article under ambient lighting and temperature conditions.

The flake can have the following dimensions, for example from about 100 nm to about 100 μm in thickness and from about 100 nm to about 1 mm in size. A composition can include the disclosed flake and a liquid medium.

The reflector layer can have a first surface, a second surface opposite the first surface; and at least one additional surface, such as a third surface. The at least one additional surface (for example, the left and/or right side of reflector) of the reflector is open to air. The at least one additional surface does not include a layer of any material, such as a selective light modulator layer, an absorber layer, and/or a dielectric layer.

Although, the article is disclosed with specific layers in specific orders, one of ordinary skill in the art would appreciate that the article can include any number of layers in any order. Additionally, the composition of any particular layer can be the same or different from the composition of any other layer. If more than one SLML is present, each SLML can be independent in terms of their respective compositions and physical properties. For example, a first SLML can have a composition with a first refractive index, but a second SLML in the same article can have a different composition with a different refractive index. As another example, a first SLML can have a composition at a first thickness, but the second SLML can have the same composition at a second thickness different from the first thickness. Additionally, or alternatively, the article in the form of a flake, sheet, or foil can also include a hard coat or protective layer on the external surfaces of the article in which the external surfaces can be those exposed to air. In some examples, these layers (hard coat or protective layer) do not require optical qualities.

The reflector layer can be a wideband reflector, e.g., spectral and Lambertian reflector (e.g., white TiO₂). The reflector layer can be a metal, non-metal, or metal alloy. In one example, the materials for the reflector layer, for example a first reflector layer and a second reflector layer, can include any materials that have reflective characteristics in the desired spectral range. For example, any material with a reflectance ranging from 5% to 100% in the desired spectral range. An example of a reflective material can be aluminum, which has good reflectance characteristics, is inexpensive, and is easy to form into or deposit as a thin layer. Other reflective materials can also be used in place of aluminum. For example, copper, silver, gold, platinum, palladium, nickel, cobalt, niobium, chromium, tin, and combinations or alloys of these or other metals can be used as reflective materials. In an aspect, the material for the at least one reflector layer can be a white or light colored metal. In other examples, the reflector layer can include, but is not limited to, the transition and lanthanide metals and combinations thereof; as well as metal carbides, metal oxides, metal nitrides, metal sulfides, a combination thereof, or mixtures of metals and one or more of these materials.

The thickness of the at least one reflector layer can range from about 5 nm to about 5000 nm, although this range should not be taken as restrictive. For example, the lower thickness limit can be selected so that the reflector layer provides a maximum transmittance of 0.8. Additionally, or alternatively, for a reflector layer including aluminum the optical density (OD) can be from about 0.1 to about 4 at a wavelength of about 550 nm.

In order to obtain a sufficient optical density and/or achieve a desired effect, a higher or lower minimum thicknesses can be required depending on the composition of the reflector layer. In some examples, the upper limit can be about 5000 nm, about 4000 nm, about 3000 nm, about 1500 nm, about 200 nm, and/or about 100 nm. In one aspect, the thickness of the at least one reflector layer can range from about 10 nm to about 5000 nm for example, from about 15 nm to about 4000 nm, from about 20 nm to about 3000 nm, from about 25 nm to about 2000 nm, from about 30 nm to about 1000 nm, from about 40 nm to about 750 nm, or from about 50 nm to about 500 nm, such as from about 60 nm to about 250 nm or from about 70 nm to about 200 nm.

The article can include a first selective light modulator layer (SLML), and for example, a second selective light modulator layer. The SLML is a physical layer comprising a plurality of optical functions aiming at modulating (absorbing and or emitting) light intensity in different, selected regions of spectrum of electromagnetic radiation with wavelengths ranging from about 0.2 μm to about 20 μm.

SLMLs (and/or the materials within the SLMLs) can selectively modulate light. For example, an SLML can control the amount of transmission in specific wavelengths. In some examples, the SLML can selectively absorb specific wavelengths of energy (e.g., in the visible and/or non-visible ranges). For example, the SLML can be a “colored layer” and/or a “wavelength selective absorbing layer.” In some examples, the specific wavelengths absorbed can cause the article, for example, in the form of a flake, to appear a specific color. For example, the SLML can appear red to the human eye (e.g., the SLML can absorb wavelengths of light below approximately 620 nm and thus reflect or transmit wavelengths of energy that appear red). This can be accomplished by adding SLMPs that are colorants (e.g., organic and/or inorganic pigments and/or dyes) to a host material, such as a dielectric material, including but not limited to a polymer. For example, in some instances, the SLML can be a colored plastic.

In some examples, some or all of the specific wavelengths absorbed can be in the visible range (e.g., the SLML can be absorbing throughout the visible, but transparent in the infrared). The resulting article, for example in the form of a flake, would appear black, but reflect light in the infrared. In some examples described above, the wavelengths absorbed (and/or the specific visible color) of the article and/or SLML can depend, at least in part, on the thickness of the SLML. Additionally, or alternatively, the wavelengths of energy absorbed by the SLML (and/or the color in which these layers and/or the flake appears) can depend in part on the addition of certain aspects to the SLML. In addition to absorbing certain wavelengths of energy, the SLML can achieve at least one of bolstering the reflector layer against degradation; enabling release from a substrate; enabling sizing; providing some resistance to environmental degradation, such as oxidation of aluminum or other metals and materials used in the reflector layer; and high performance in transmission, reflection, and absorption of light based upon the composition and thickness of the SLML.

In some examples, in addition to or as an alternative to the SLMLs selectively absorbing specific wavelengths of energy and/or wavelengths of visible light, the SLMLs of the article can control the refractive index and/or the SLMLs can include SLMPs that can control refractive index. SLMPs that can control the refractive index of the SLML can be included with the host material in addition to or as an alternative to an absorption controlling SLMPs (e.g., colorants). In some examples, the host material can be combined with both absorption controlling SLMPs and refractive index SLMPs in the SLMLs. In some examples, the same SLMP can control both absorption and refractive index.

The performance of the SLML can be determined based upon the selection of materials present in the SLML. In an aspect, the SLML can improve at least one of the following properties: flake handling, corrosion, alignment, and environmental performance of any other layers within article, e.g., the reflector layer.

The first and second SLML can each independently comprise a host material alone, or a host material combined with a selective light modulator system (SLMS). In an aspect, at least one of the first SLML and the second SLML includes a host material. In another aspect, at least one of the first SLML and the second SLML includes a host material and a SLMS. The SLMS can include a selective light modulator molecule (SLMM), a selective light modulator particle (SLMP), an additive, or combinations thereof.

The composition of the SLML can have a solids content ranging from about 0.01% to about 100%, for example from about 0.05% to about 80%, and as a further example from about 1% to about 30%. In some aspects, the solids content can be greater than 3%. In some aspects, the composition of the SLMLs can have a solids content ranging from about 3% to about 100%, for example from about 4% to 50%.

The host material of each of the first and/or second SLMLs can independently be a film forming material applied as a coating liquid and serving optical and structural purposes. The host material can be used as a host (matrix) for introducing, if necessary, a guest system, such as the selective light modulator system (SLMS), for providing additional light modulator properties to the article.

The host material can be a dielectric material. Additionally, or alternatively, the host material can be at least one of an organic polymer, an inorganic polymer, and a composite material. Non-limiting examples of the organic polymer include thermoplastics, such as polyesters, polyolefins, polycarbonates, polyamides, polyimides, polyurethanes, acrylics, acrylates, polyvinylesters, polyethers, polythiols, silicones, fluorocarbons, and various co-polymers thereof; thermosets, such as epoxies, polyurethanes, acrylates, melamine formaldehyde, urea formaldehyde, and phenol formaldehyde; and energy curable materials, such as acrylates, epoxies, vinyls, vinyl esters, styrenes, and silanes. Non-limiting examples of inorganic polymers includes silanes, siloxanes, titanates, zirconates, aluminates, silicates, phosphazanes, polyborazylenes, and polythiazyls.

Each of the first and second SLMLs can include from about 0.001% to about 100% by weight of a host material. In an aspect, the host material can be present in the SLML in an amount ranging from about 0.01% to about 95% by weight, for example from about 0.1% to about 90%, and as a further example from about 1% to about 87% by weight of the SLML.

The SLMS, for use in the SLMLs with the host material, can each independently comprise selective light modulator particles (SLMP), selective light modulator molecules (SLMM), additives, or a combination thereof. The SLMS can also comprise other materials. The SLMS can provide modulation of the amplitude of electromagnetic radiation (by absorption, reflectance, fluorescence etc.) in a selective region or the entire spectral range of interest (0.2 μm to 20 μm).

The first and second SLMLs can each independently include in an SLMS a SLMP. The SLMP can be any particle combined with the host material to selectively control light modulation, including, but not limited to color shifting particles, dyes, colorants include one or more of dyes, pigments, reflective pigments, color shifting pigments, quantum dots, and selective reflectors. Non-limiting examples of a SLMP include: organic pigments, inorganic pigments, quantum dots, nanoparticles (selectively reflecting and/or absorbing), micelles, etc. The nanoparticles can include, but are not limited to organic and metalorganic materials having a high value of refractive index (n>1.6 at wavelength of about 550 nm); metal oxides, such as TiO₂, ZrO₂, In₂O₃, In₂O₃—SnO, SnO₂, FeₓO_{y} (wherein x and y are each independently integers greater than 0), and WO₃; metal sulfides, such as ZnS, and CuₓS_{y} (wherein x and y are each independently integers greater than 0); chalcogenides, quantum dots, metal nanoparticles; carbonates;

fluorides; and mixtures thereof.

The colorant for use as an SLMP in the SLML can have a first color that changes to a second color upon application of energy. The first color and the second color are different, for example, in terms of hue, brightness, and/or chroma. The color can be determined by using the CIELAB color system. The first color and the second color can be visualized by the naked eye. In an aspect, the first color can be colorless so that the colorant changes from colorless (first color) to a second color. In another aspect, the second color can be colorless so that the colorant changes from a first color to colorless (second color).

The colorant for use in the SLML can be a thermochromic dye or a photochromic dye. The colorant can be a mixture of colorants, such as two or more colorants, wherein each colorant of the mixture of colorants independently has a first color that changes to a second color upon application of energy. A thermochromic dye can change color from a first color to a second color upon application of energy, in the form of a temperature change, such as hot to cold or vice versa. A thermochromic dye can be an organic material, such as a leuco dye. Non-limiting examples of organic materials for use a thermochromic dye include a spirolactone, fluoran, spiropyrans, and fulgides.

The colorant can also include inorganic materials that exhibit a thermochromic color shift (from a first color to a second color), such as titanium dioxide, zinc sulfide, zinc oxide, indium (III) oxide, lead (II) oxide, cuprous mercury iodide, silver mercury iodide, mercury (II) iodide, bis(dimethylammonium)tetrachloronickelate (II), bis(diethylammonium)tetrachlorocuprate (II), chromium (III) oxide:aluminum(III)oxide, vanadium dioxide, copper (I) iodide, ammonium metavanadate, manganese violet, and combinations thereof.

A photochromic dye can change color from a first color to a second color upon application of energy, in the form of absorption of electromagnetic radiation. Non-limiting examples of a photochromic dye for use a colorant include triarylmethane, stilbene, azastilbene, nitrone, fulgide, spiropyran, naphthopyran, spiro-oxazine, quinone, diarylethene, azobenzene, silver chloride, zinc halide, yttrium hydride, hexaarylbiimidazole, spiropermidine, and combinations thereof.

The energy that is applied to the article can be any energy that effects a color change in the selective light modulating layer. In an aspect, the energy can be electromagnetic, such as magnetic energy and light from all spectral ranges including from gamma to shortwave; high energy particles; thermal; light; heat; bioenergy, such as solar, wind, hydroelectric, wave, heat; nuclear; mechanical; chemical; etc. The energy can be applied to the article for any period of time sufficient to effect the color change of the selective light modulating layer.

In an aspect, the colorant in the SLML can change from a first color under low light intensity viewing conditions to a second color under high light intensity viewing conditions upon application of light that produces a change in hue and brightness in the colorant. The colorant can be a tungsten silver pigment with active self-tuning color parameters. In particular, by selecting the colorant, including a mixture of colorants, the time period for the application of energy, and the type of energy to be applied one can form an article with particular first color and second color, which can be exhibit the best color effect under specific lighting conditions.

It is also possible to achieve a tuning effect by providing one or more colorants in one or more SLML, such as a stack of SLML located on a first surface of a reflector layer and/or on a second surface of a reflector layer. An exemplary article can have the following structure: 6SLML/5SLML/4SLML/reflector/3SLML/2SLML/1SLML, in which each SLML (1-6SLML) independently can include the same or different colorant, as described above.

Examples of a SLMM include but are not limited to: organic dyes, inorganic dyes, micelles, and other molecular systems containing a chromophore. In an aspect, the SLMM can be a material chosen from a colored pigment, a light-fast dye, and a quantum dot.

In some aspects, SLMS of each of the first and second SLMLs can include at least one additive, such as a curing agent, and a coating aid.

The curing agent can be a compound or material that can initiate hardening, vitrification, crosslinking, or polymerizing of the host material. Non-limiting examples of a curing agent include solvents, radical generators (by energy or chemical), acid generators (by energy or chemical), condensation initiators, and acid/base catalysts.

Non-limiting examples of the coating aid include leveling agents, wetting agents, defoamers, adhesion promoters, antioxidants, UV stabilizers, curing inhibition mitigating agents, antifouling agents, corrosion inhibitors, photosensitizers, secondary crosslinkers, and infrared absorbers for enhanced infrared drying. In an aspect, the antioxidant can be present in the composition of the SLML in an amount ranging from about 25 ppm to about 5% by weight.

The first and second SLMLs can each independently comprise a solvent. Non-limiting examples of solvents can include acetates, such as ethyl acetate, propyl acetate, and butyl acetate; acetone; water; ketones, such as dimethyl ketone (DMK), methylethyl ketone (MEK), secbutyl methyl ketone (SBMK), ter-butyl methyl ketone (TBMK), cyclopenthanon, and anisole; glycol and glycol derivatives, such as propylene glycol methyl ether, and propylene glycol methyl ether acetate; alcohols, such as isopropyl alcohol, and diacetone alcohol; esters, such as malonates; heterocyclic solvents, such as n-methyl pyrrolidone; hydrocarbons, such as toluene, and xylene; coalescing solvents, such as glycol ethers; and mixtures thereof. In an aspect, the solvent can be present in each of the first and second SLML in an amount ranging from about 0% to about 99.9%, for example from about 0.005% to about 99%, and as a further example from about 0.05% to about 90% by weight relative to the total weight of the SLML.

In some examples, the first and second SLML can each independently include a composition having at least one of (i) a photoinitiator, (ii) an oxygen inhibition mitigation composition, (iii) a leveling agent, and (iv) a defoamer.

The oxygen inhibition mitigation composition can be used to mitigate the oxygen inhibition of the free radical material. The molecular oxygen can quench the triplet state of a photoinitiator sensitizer or it can scavenge the free radicals resulting in reduced coating properties and/or uncured liquid surfaces. The oxygen inhibition mitigation composition can reduce the oxygen inhibition or can improve the cure of any SLML.

The oxygen inhibition composition can comprise more than one compound. The oxygen inhibition mitigation composition can comprise at least one acrylate, for example at least one acrylate monomer and at least one acrylate oligomer. In an aspect, the oxygen inhibition mitigation composition can comprise at least one acrylate monomer and two acrylate oligomers. Non-limiting examples of an acrylate for use in the oxygen inhibition mitigation composition can include acrylates; methacrylates; epoxy acrylates, such as modified epoxy acrylate; polyester acrylates, such as acid functional polyester acrylates, tetra functional polyester acrylates, modified polyester acrylates, and bio-sourced polyester acrylates; polyether acrylates, such as amine modified polyether acrylates including amine functional acrylate co-initiators and tertiary amine co-initiators; urethane acrylates, such aromatic urethane acrylates, modified aliphatic urethane acrylates, aliphatic urethane acrylates, and aliphatic allophanate based urethane acrylates; and monomers and oligomers thereof. In an aspect, the oxygen inhibition mitigation composition can include at least one acrylate oligomer, such as two oligomers. The at least one acrylate oligomer can be selected/chosen from a polyester acrylate and a polyether acrylate, such as a mercapto modified polyester acrylate and an amine modified polyether tetraacrylate. The oxygen inhibition mitigation composition can also include at least one monomer, such as 1,6-hexanediol diacrylate. The oxygen inhibition mitigation composition can be present in the first and/or second SLML in an amount ranging from about 5% to about 95%, for example from about 10% to about 90%, and as a further example from about 15% to about 85% by weight relative to the total weight of the SLML.

In some examples, the host material of the SLML can use a non-radical cure system such as a cationic system. Cationic systems are less susceptible to the mitigation of the oxygen inhibition of the free radical process, and thus may not require an oxygen inhibition mitigation composition. In an example, the use of the monomer 3-Ethyl-3-hydroxymethyloxetane does not require an oxygen mitigation composition.

In an aspect, the first and second SLML can each independently include at least one photoinitiator, such as two photoinitiators, or three photoinitiators. The photoinitiator can be used for shorter wavelengths. The photoinitiator can be active for actinic wavelength. The photoinitiator can be a Type 1 photoinitiator or a Type II photoinitiator. The SLML can include only Type I photoinitiators, only Type II photoinitiators, or a combination of both Type I and Type II photoinitiators. The photoinitiator can be present in the composition of the SLML in an amount ranging from about 0.25% to about 15%, for example from about 0.5% to about 10%, and as a further example from about 1% to about 5% by weight relative to the total weight of the composition of the SLML.

The photoinitiator can be a phosphineoxide. The phosphineoxide can include, but is not limited to, a monoacyl phosphineoxide and a bis acyl phosphine oxide. The mono acyl phosphine oxide can be a diphenyl (2,4,6-trimethylbenzoyl)phosphineoxide. The bis acyl phosphine oxide can be a bis (2,4,6-trimethylbenzoyl)phenylphosphineoxide. In an aspect, at least one phosphineoxide can be present in the composition of the SLML. For example, two phosphineoxides can be present in the composition of the SLML.

A sensitizer can be present in the composition of the SLML and can act as a sensitizer for Type 1 and/or a Type II photoinitiators. The sensitizer can also act as a Type II photoinitiator. In an aspect, the sensitizer can be present in the composition of the SLML in an amount ranging from about 0.05% to about 10%, for example from about 0.1% to about 7%, and as a further example from about 1% to about 5% by weight relative to the total weight of the composition of the SLML. The sensitizer can be a thioxanthone, such as 1-chloro-4-propoxythioxanthone.

In an aspect, the SLML can include a leveling agent. The leveling agent can be a polyacrylate. The leveling agent can eliminate cratering of the composition of the SLML. The leveling agent can be present in the composition of the SLML in an amount ranging from about 0.05% to about 10%, for example from about 1% to about 7%, and as a further example from about 2% to about 5% by weight relative to the total weight of the composition of the SLML.

The SLML can also include a defoamer. The defoamer can reduce surface tension. The defoamer can be a silicone free liquid organic polymer. The defoamer can be present in the composition of the SLML in an amount ranging from about 0.05% to about 5%, for example from about 0.2% to about 4%, and as a further example from about 0.4% to about 3% by weight relative to the total weight of the composition of the SLML.

The first and second SLML can each independently have a refractive index of greater or less than about 1.5. For example, each SLML can have a refractive index of approximately 1.5. The refractive index of each SLML can be selected to provide a degree of color travel required wherein color travel can be defined as the change in hue angle measured in L*a*b* color space with the viewing angle. In some examples, each SLML can include a refractive index in a range of from about 1.1 to about 3.0, about 1.0 to about 1.3, or about 1.1 to about 1.2. In some examples, the refractive index of each SLML can be less than about 1.5, less than about 1.3, or less than about 1.2. In some examples, a first SLML and a second SLML can have substantially equal refractive indexes or different refractive indexes one from the other.

The first and second SLML can each independently have a thickness ranging from about 1 nm to about 10000 nm, about 10 nm to about 1000 nm, about 20 nm to about 500 nm, about 1 nm, to about 100 nm, about 10 nm to about 1000 nm, about 1 nm to about 5000 nm. In an aspect, the article, such as an optical device, can have an aspect ratio of 1:1 to 1:50 thickness to width.

One of the benefits of the article described herein, however, is that, in some examples, the optical effects appear relatively insensitive to thickness variations. Thus, in some aspects, each SLML can independently have a variation in optical thickness of less than about 5%. In an aspect, each SLML can independently include an optical thickness variation of less than about 3% across the layer. In an aspect, each SLML can independently have less than about 1 variation in optical thickness across the layer having a thickness of about 50 nm.

In an aspect, the article, such as an optical device in the form of a flake, foil or sheet, can also include a substrate and an optional release layer. In an aspect, the release layer can be disposed between the substrate and the first SLML.

The article, such as optical devices, described herein can be made in any way and then divided, broken, ground, etc. into smaller pieces. In some examples, the article can be made using at least one production process, for example a vacuum deposition process and a liquid coating process, including, but not limited to the processes described below.

There is disclosed a method for manufacturing an article, for example in the form of a sheet, flake, or foil, as described herein. The method can comprise depositing on a substrate a first SLML; depositing on the first SLML at least one reflector layer; and depositing on the at least one reflector a second SLML; wherein at least one of the first SLML and the second SLML is deposited using a liquid coating process.

An article, such as an optical device, in the form of a flake, sheet, or foil, can be created by depositing a first SLML on a substrate. The substrate can optionally include a release layer. In an aspect, the method can include depositing on the substrate, having an optional release layer, a first SLML, and depositing on the first SLML at least one reflector layer. The method further includes depositing on the at least one reflector layer, a second SLML. In some examples, the at least one reflector layer can be applied to the respective layers by any known conventional deposition process, such as physical vapor deposition, chemical vapor deposition, thin-film deposition, atomic layer deposition, etc., including modified techniques such as plasma enhanced and fluidized bed.

The substrate can be made of a flexible material. The substrate can be any suitable material that can receive the deposited layers. Non-limiting examples of suitable substrate materials include polymer web, such as polyethylene terephthalate (PET), glass foil, glass sheets, polymeric foils, polymeric sheets, metal foils, metal sheets, ceramic foils, ceramic sheets, ionic liquid, paper, silicon wafers, etc. The substrate can vary in thickness, but can range for example from about 2 μm to about 100 μm, and as a further example from about 10 to about 50 μm.

The first SLML can be deposited on the substrate by a liquid coating process, such as a slot die process. Once the first SLML has been deposited and cured, the at least one reflector can be deposited on the first SLML using any conventional deposition processes described above. After the at least one reflector layer has been deposited on the first SLML, the second SLML can be deposited on the at least one reflector via a liquid coating process, such as a slot die process. The liquid coating process includes, but is not limited to: slot-bead, slide bead, slot curtain, slide curtain, in single and multilayer coating, tensioned web slot, gravure, roll coating, and other liquid coating and printing processes that apply a liquid on to a substrate to form a liquid layer or film that is subsequently dried and/or cured to the final SLML layer.

The substrate can then be released from the deposited layers to create the article. In an aspect, the substrate can be cooled to embrittle an associated release layer. In another aspect, the release layer could be embrittled, for example by heating and/or curing with photonic or e-beam energy, to increase the degree of cross-linking, which would enable stripping. The deposited layers can then be stripped mechanically, such as sharp bending or brushing of the surface, or air-stripping. The released and stripped layers can be sized into article, such as an optical device in the form of a flake, foil, or sheet, using known techniques.

In another aspect, the deposited layers can be transferred from the substrate to another surface. The deposited layers can be punched or cut to produce large flakes with well-defined sizes and shapes.

As stated above, each of the first and second SLML can be deposited by a liquid coating process, such as a slot die process. However, it was previously believed that liquid coating processes, such as a slot die process, could not operate stably at optical thicknesses, such as from about 50 to about 700 nm. In particular, thin, wet films have commonly formed islands of thick areas where solids have been wicked away from the surrounding thin areas by capillary forces as solvents evaporate. This reticulated appearance is not compatible with optical coatings as the variable thickness can result in a wide range of optical path lengths, such as a side range of colors resulting in a speckled/textured appearance, as well as reduced color uniformity of the optical coating and low chromaticity.

The liquid coating process can allow for the transfer of the composition of the SLML at a faster rate as compared to other deposition techniques, such as vapor deposition. Additionally, the liquid coating process can allow for a wider variety of materials to be used in the SLML with a simple equipment set up. It is believed that the SLML formed using the disclosed liquid coating process can exhibit improved optical performance.

There is also disclosed a composition including the disclosed article, such as in the form of a flake, and a liquid medium. The composition can be a paint, varnish, or an ink and can be used as a security feature for currency. The liquid medium can be any medium, such as water, organic solvent, etc. The flakes in the composition can include a plurality of flakes. In an aspect, each flake in the plurality of flakes can include a first selective light modulator layer that is different. In this manner, “different” is intended to mean that at least one feature of two selective light modular layers is not the same, such as different components (e.g., two different colorants), different optical or physical thicknesses, etc. For example, a first flake having a first selective light modulator layer can include a colorant that changes from red to orange and a second flake having a first selective light modulator layer can include the same colorant but can have a different optical thickness.

A method of making the composition can include providing a flake including a reflector layer having a first surface, and a second surface opposite the first surface; and a first selective light modulator layer external to the first surface; wherein the first selective light modulator layer includes a colorant having a first color that changes to a second color upon application of energy; blending a liquid medium with the flake; and applying energy to the composition to tune the first selective light modulator layer in each flake from the first color to the second color.

The applied energy can come from any light source to provide light. The light can include any wavelength across the electromagnetic spectrum, such as ultraviolet, visible, infrared, etc. In another aspect, the applied energy can come from any heat source to provide a change in temperature from cold to hot or hot to cold.

From the foregoing description, those skilled in the art can appreciate that the present teachings can be implemented in a variety of forms. Therefore, while these teachings have been described in connection with particular embodiments and examples thereof, the true scope of the present teachings should not be so limited. Various changes and modifications can be made without departing from the scope of the teachings herein.

This scope disclosure is to be broadly construed. It is intended that this disclosure disclose equivalents, means, systems and methods to achieve the devices, activities and mechanical actions disclosed herein. For each device, article, method, mean, mechanical element or mechanism disclosed, it is intended that this disclosure also encompass in its disclosure and teaches equivalents, means, systems and methods for practicing the many aspects, mechanisms and devices disclosed herein. Additionally, this disclosure regards a coating and its many aspects, features and elements. Such a device can be dynamic in its use and operation, this disclosure is intended to encompass the equivalents, means, systems and methods of the use of the device and/or optical device of manufacture and its many aspects consistent with the description and spirit of the operations and functions disclosed herein. The claims of this application are likewise to be broadly construed. The description of the inventions herein in their many embodiments is merely exemplary in nature and, thus, variations that do not depart from the gist of the invention are intended to be within the scope of the invention. Such variations are not to be regarded as a departure from the spirit and scope of the invention.

What is claimed is:

1. A flake comprising:
a reflector layer having a first surface, and a second surface opposite the first surface; and
a first selective light modulator layer external to the first surface;
wherein the first selective light modulator layer includes a colorant having a first color that changes to a second color upon application of energy.

2. The flake of claim 1, wherein the colorant is a thermochromic dye.

3. The flake of claim 1, wherein the colorant is a photochromic dye.

4. The flake of claim 1, wherein the colorant includes two or more colorants.

5. The flake of claim 4, wherein each of the two or more colorants independently have a first color that changes to a second color upon application of energy.

6. The flake of claim 2, wherein the thermochromic dye is a leuco dye.

7. The flake of claim 3, wherein the photochromic dye is a spiropyran.

8. The flake of claim 1, further comprising a second selective light modulator layer external to the second surface.

9. The flake of claim 8, wherein the second selective light modulator layer includes a colorant having a first color that changes to a second color upon application of energy.

10. The flake of claim 1, further comprising a stack of selective light modulator layers on the second surface, and wherein each layer of the stack of the selective light modulator layers includes a colorant having a first color that changes to a second color upon application of energy.

11. The flake of claim 1, further comprising a second selective light modulator layer that is different from the first selective light modulator layer.

12. The flake of claim 1, wherein the first selective light modulator layer includes a selective light modulator material.

13. The flake of claim 12, wherein the selective light modulator material is chosen from a colored pigment, a light-fast dye, and a quantum dot.

14. A composition comprising the flake of claim 1; and a liquid medium.

15. The composition of claim 14, wherein the flake is a plurality of flakes.

16. The composition of claim 15, wherein each flake in the plurality of flakes includes a first selective light modulator layer that is different.

17. A method of making a composition, comprising:
providing a flake including a reflector layer having a first surface, and a second surface opposite the first surface; and a first selective light modulator layer external to the first surface;
wherein the first selective light modulator layer includes a colorant having a first color that changes to a second color upon application of energy;
blending a liquid medium with the flake; and
applying energy to the composition to tune the first selective light modulator layer in each flake from the first color to the second color.

18. The method of claim 17, wherein the applied energy is applied light.

19. The method of claim 17, wherein the applied energy is applied heat.

20. The method of claim 17, wherein the colorant is chosen from a thermochromic dye and a photochromic dye.
